(19) United States
(12) Patent Application Publication
(10) Pub. No.: US 2005/0091202 A1
(43) Pub. Date: Apr. 28, 2005

(54) Social network-based internet search engine

(76) Inventor: Kapenda J. Thomas, Renton, WA (US)

Correspondence Address: BLACK LOWE & GRAHAM, PLLC, 701 FIFTH AVENUE, SUITE 4800, SEATTLE, WA, 98104, US

(21) Appl. No.: 10/783,575

(22) Filed: Feb. 20, 2004

Related U.S. Application Data
(60) Provisional application No. 60/513,852, filed on Oct. 22, 2003.
(60) Provisional application No. 60/538,515, filed on Jan. 23, 2004.

(51) Int. Cl. G06F 7/00

(52) U.S. Cl. 707/3

(57) ABSTRACT

Filtering Internet content includes receiving a search query message comprising a search query to an Internet search engine. Data is received from the Internet search engine, responsive to the search query message. Filtering of the data produces a data subset. The filter selects data for inclusion in the data subset based upon occurrence of the data in a database. The database includes content selected for inclusion by designated users. The data subset is displayed in a browser.

### PRIORITY CLAIM

This application claims priority from the provisional application entitled TRUSTED FRIEND BASED INTERNET SEARCH ENGINE with Ser. No. 60/513,852 filed on Oct. 22, 2003 and from the provisional application entitled SOCIAL NETWORK-BASED INTERNET SEARCHING with Ser. No. 60/538,515 filed on Jan. 23, 2004. Both provisional applications are incorporated by this reference.

### FIELD OF THE INVENTION

This invention relates generally to Internet search engines and, more specifically, to social network-based Internet search engines.

### BACKGROUND OF THE INVENTION

Currently the Worldwide Web (all the resources and users on the Internet that are using the Hypertext Transfer Protocol) contains registration for over 3 billion URLs. The amount of Internet content continues to grow rapidly and to outpace the ability of search engines to index the exploding amount of information. The largest search engines cannot keep up with the growth as it has been estimated that search engines only index about 5% to 30% of the information content on the Web. Hence, at the current time, the majority of Web content is not classified or indexed by any search engine.

To make information accessible to the searcher, providers accumulate directories of information that is indexed and therefore searchable. One approach has been the use of Web Directories; content editors to manually categorize and recommend sites to build LDAP directories. Relying upon human editors to manually go through and survey sites on the Web is slow and expensive for the provider and is inherently more expensive at the expanding rate at which the Internet grows.

Recently, the traditional Web client-server paradigm has been challenged by distributed file-sharing systems that support a peer-to-peer model for exchanging data. In peer-to-peer networks, each computer platform, or node, can operate as a hub, i.e., each node has both client functionality and server functionality. Each node has a list of addresses, most commonly Internet Protocol (IP) addresses, of several other nodes, or “peer nodes”. These nodes can directly communicate with each other without a central or intermediate server.

Nodes within a peer-to-peer network form a distributed file-sharing system in which the nodes act cooperatively to form a distributed search engine. When a user at a node enters a search query, the search query is copied and sent to its list of peer nodes. Each peer node searches its own databases in an attempt to satisfy the search query. Each node copies the query to each node in its list of peer nodes while observing a time-to-live value in the query message. If a resulting query hit is made, then the node returns some type of query results to the originating node. The search quickly fans out amongst a large number of nodes, which provides a useful manner for finding new content that has not yet been indexed by the large search engines.

In addition to remaining up to date, an effective search engine must rank information. The changing nature of the information stored on the Worldwide Web drives the need for not merely locating information but also for winnowing the information to limit the returned information to such that is relevant to the user. It would be advantageous to sort information according to a criterion that will conform with the interests of the user. Because so many users do access the Web, it would be advantageous to sort information according to the recommendation of other users of the Web. Further advantages accrue if the other users of the Web are within the interest groups or buddy lists selected and defined by current user.

Since the Web is a dynamic environment where content is constantly being added, updated, and changed, it is very difficult for the search engines to be and to remain up-to-date. Therefore, it would be advantageous to provide a method and system for augmenting traditional searches of Internet-based content. It would be particularly advantageous to use aspects of peer-to-peer networks to assist in obtaining relevant search results.

### SUMMARY OF THE INVENTION

Filtering Internet content includes receiving a search query message comprising a search query to an Internet search engine. Data is received from the Internet search engine, responsive to the search query message. Filtering of the data produces a data subset. The filter selects data for inclusion in the data subset based upon occurrence of the data in a database. The database includes content selected for inclusion by designated users. The data subset is displayed in a browser.

In accordance with still further aspects of the invention, based upon accessing the user's Web filters as well as the Web filters of other selected users, the present invention includes the functionality to persist, search and retrieve views of information. Formulating algorithms to reflect an individual's own preferences entails a lengthy training period requiring numerous individual selections. The present invention, rather, leverages the Web experiences of a number of individuals that the user selects as reflective of the user's own preferences. The collective experience of a whole social network of the number of individuals more rapidly populates a filter or set of filter to build a greater likelihood of locating information that will satisfy a user's needs according to their preferences. Additionally, the user can use the invention to save and to manipulate views and to add or remove individuals from the number of individuals.

In accordance with yet other aspects of the invention, the invention also provides an ability to push an advertisement from a third party advertiser. By means of information garnered from the recurrent searches by the number of individuals making up a social network, the advertiser can target only advertising consistent with the desires of the individuals as expressed in their regular searching activities. Each view saved in association with one or more of the individuals in the social network has multiple associated categories based upon the URL's saved within a specific view. By using the category information an advertiser can be specifically target a user or groups of users within a social network, or a defined subset of that network. The targeting function can be further enhanced by the roles that the user selects to identify the user (i.e.: Runner, Attorney, Children, Teen, etc) thereby revealing demographic information. Where users in the social network do react in a trackable means to the advertisement, the reactions can be associated with the individuals in the social network to provide further indication as to the match between the advertisement and the social network.

In accordance with still another aspect of the invention, the invention provides the user the ability to recommend a site to a friend or colleague while perusing a site in real-time. The recommendation engine will send an introduction email to the user along with a site recommendation to enable the potential new user to become social network member. The recommendation engine will provide the ability to track recommendations.

As will be readily appreciated from the foregoing summary, the invention provides an integrated enhancement to an Internet search engine that is both platform-independent and will work with one or several search engines. The results, in fact, are enhanced if the individuals in the social network do use diverse distinct search engines.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2A is a block diagram that depicts a simplified, Internet-based connection between two computers;

FIG. 2B is a block diagram that depicts software components within two computers that are operating as nodes within a peer-to-peer network;

FIG. 2C is a block diagram depicting typical software subcomponents within a peer-to-peer software component that contains file sharing functionality;

FIG. 2D is a block diagram depicting a typical network topology of nodes within a peer-to-peer network;

FIG. 3 depicts a typical, Web-based, indexing-type, search engine;

FIG. 4 depicts a database chart depicting an example of a social network searching filter;

FIG. 5A is a network topology depicting an example of a client-server graphical embodiment of a social network searching filter;

FIG. 5B is a network topology depicting an example of a serverless peer-to-peer graphical embodiment of a social network searching filter;

FIG. 5C is a network topology depicting an example of a server-steered peer-to-peer graphical embodiment of a social network searching filter;

FIG. 5D is a network topology depicting an example of an extended server-steered peer-to-peer graphical embodiment of a social network searching filter;

FIG. 6A is a diagram showing a set of URLs within the HTML source code of a search result that has been generated in accordance with a preferred embodiment of the present invention;

FIG. 6B is a diagram showing a set of URLs within the HTML source code of a search result that has been generated in accordance with a preferred embodiment of the present invention;

FIG. 7A is a diagram depicting an example of a dialogue box used to augment a defined group of users;

FIG. 7B is a diagram depicting an example of a dialogue box used to recommend a website to a defined group of users; and

FIG. 8 is a flowchart depicting an overall process for providing an augmented search in accordance with the present invention;

### DETAILED DESCRIPTION OF THE PREFERRED EMBODIMENT

By way of overview, filtering Internet content includes receiving a search query message comprising a search query to an Internet search engine. Data is received from the Internet search engine, responsive to the search query message. Filtering of the data produces a data subset. The filter selects data for inclusion in the data subset based upon occurrence of the data in a database. The database includes content selected for inclusion by designated users. The data subset is displayed in a browser.

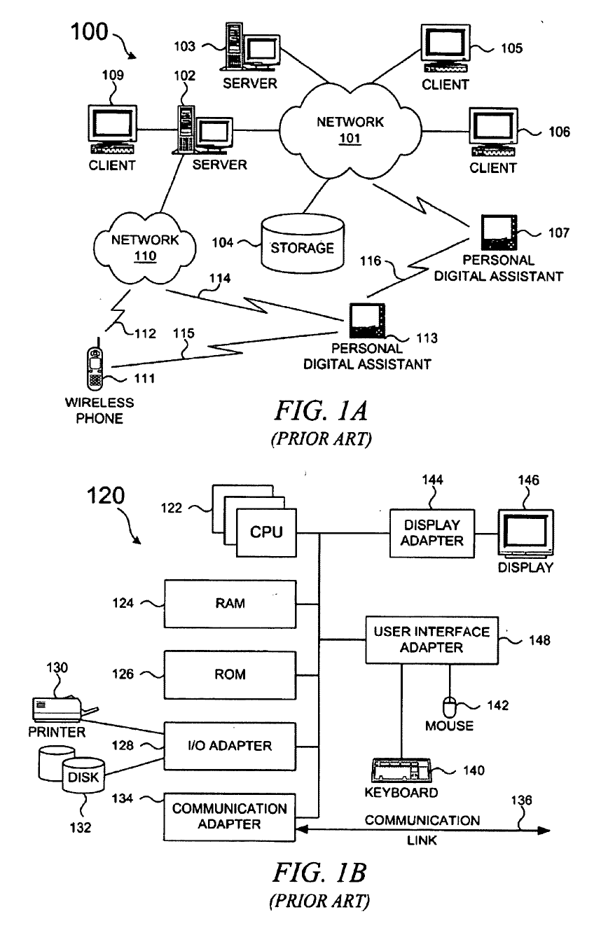

With reference now to the figures, FIG. 1A depicts a typical network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth.™. wireless technology, to create so-called personal area networks (PAN) or personal ad-hoc networks. In a similar manner, PDA 113 can transfer data to PDA 117 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel.RTM. Pentium.RTM.-based processor and a digital signal processor (DSP), and one or more types of volatile and non-volatile memory. Other peripheral devices may be used in addition to or in place of the hardware depicted in FIG. 1B. In other words, one of ordinary skill in the art would not expect to find similar components or architectures within a Web-enabled or network-enabled phone and a fully featured desktop workstation. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix.RTM. operating system, while another device contains a simple Java.RTM. runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files. Hence, it should be noted that the distributed data processing system shown in FIG. 1A is contemplated as being fully able to support a variety of peer-to-peer subnets and peer-to-peer services.

The present invention may be implemented on a variety of hardware and software platforms, as described above. More specifically, though, the present invention is directed to providing a method and system for accessing information on a network that includes peer-to-peer networks or subnets. As background, a typical organization of software components within a peer-to-peer network is described before describing the present invention in more detail.

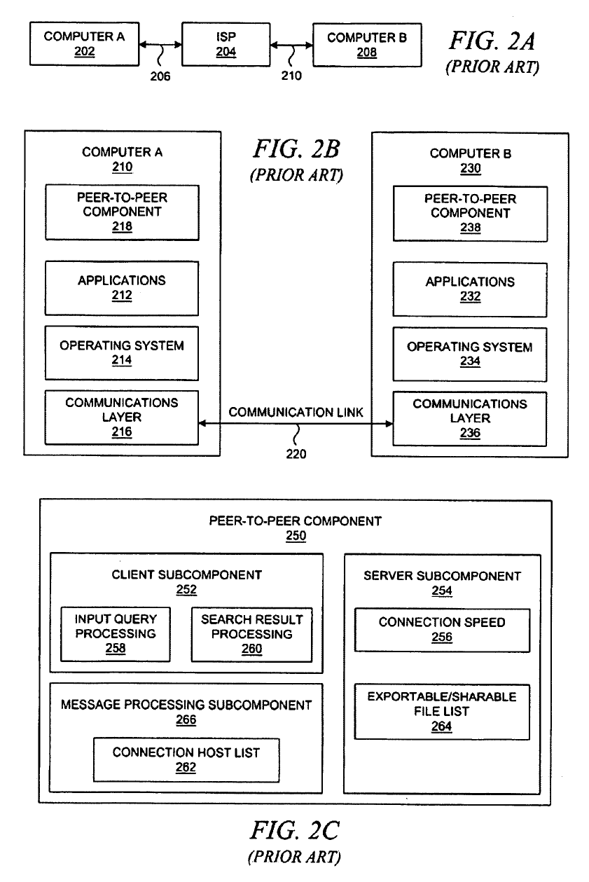

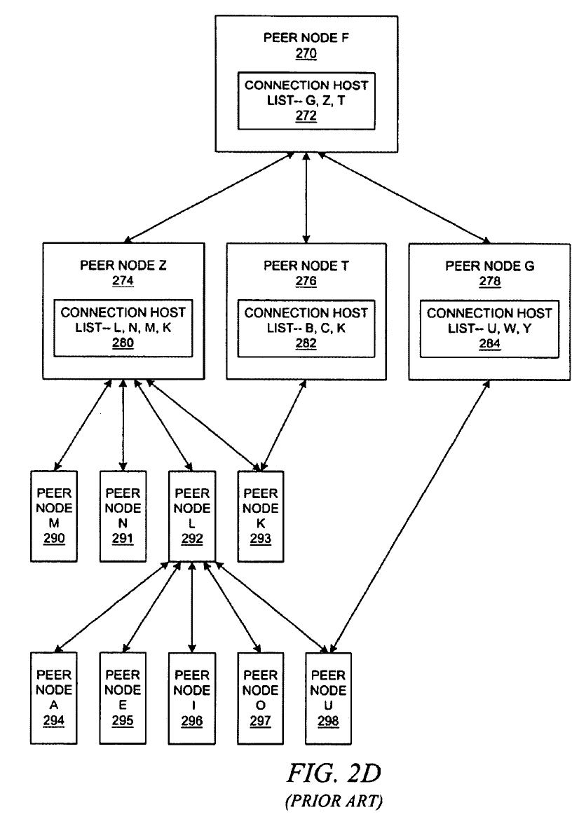

While the invention may be used in a server to client relationship, the more complex peer-to-peer embodiment better describes the features and embodiment of the invention. To describe the peer-to-peer environment, some background is necessary. With reference now to FIG. 2A, a block diagram depicts a simplified, Internet-based connection between two computers. Computer 202 communicates with ISP (Internet Service Provider) 204 across communication link 206, and computer 208 communicates with ISP 204 across communication link 210. Users of computers 202 and 208 can employ browsers and other networked applications, such as a peer-to-peer file sharing application, to send and receive information across a network, which includes the Internet in this example. Those of ordinary skill in the art will recognize that Internet-based connections between nodes 204 and 208 also may be achieved without using an ISP. For example, a Local Area Network or corporate intranet may be used. The use of an ISP is not intended to be an architectural limitation of the present invention.

With reference now to FIG. 2B, a block diagram depicts software components within two computers that are operating as nodes within a peer-to-peer network. Computer 210 has network-enabled applications 212 that use operating system 214 for various services, such as network communication services provided by communications layer 216. In addition, peer-to-peer component 218 may be a stand-alone applet or an application that provides peer-to-peer networking functionality to computer 210. Communication link 220 supports data traffic between computer 210 and computer 230, which has software components that correspond to those shown in computer 210: applications 232, operating system 234, communications layer 236, and peer-to-peer component 238. Peer-to-peer components 218 and 238 may provide support for a distributed, peer-to-peer file sharing function, as shown in more detail in FIG. 2C.

With reference now to FIG. 2C, a block diagram depicts typical software subcomponents within a peer-to-peer software component that contains file-sharing functionality. As noted previously, in peer-to-peer networks, each computer platform, or node, can operate as a hub, i.e., each node has both client functionality and server functionality. Peer-to-peer component 250 contains client subcomponent 252 and server subcomponent 254.

The method by which nodes in a peer-to-peer network connect with each other may vary with the type of peer-to-peer network. Generally, a client is dynamically assigned an IP address by an ISP when the client connects to the ISP, so the IP address possibly changes with each client session. In some implementations, a peer-to-peer connection between nodes in a peer-to-peer network is initiated when a user at a node manually enters either a domain name or an IP address (and optionally a port number) of an application of another node that is known to support peer-to-peer networking. The peer-to-peer application then establishes a connection with the other node at the specified address as a starting point within the network.

For example, applications using the Gnutella protocol operate in this manner. Gnutella nodes also exchange connection speed, such as connection speed 256, that describe the speed of the network connection that is being used by the node. It should be noted, however, that the present invention can be implemented on a variety of peer-to-peer networks and is not limited by the peer-to-peer protocol that is used by the file sharing applications.

Nodes within a peer-to-peer network can act as a distributed file sharing system in which the nodes act cooperatively to form a distributed search engine. Client subcomponent 252 contains input query processing function 258 and search result processing function 260. When a user at a node enters a search query, the search query is copied to a list of peer nodes to which the node is connected, such as connection host list 262.

When a node receives the query, its server component, such as server component 254, processes the query. Each peer node searches its own databases in an attempt to satisfy the search query. Alternatively, a user has previously specified a list of files that the user is willing to export or share, such as file list 264, and the server subcomponent searches this list to find one or more files that satisfy the search query. Alternatively, rather than searching through a list of file names, the application may search the node's permanent storage for content that matches the search query. Depending on certain parameters within the query message, the node also forwards the query, e.g., by using message processing subcomponent 266, to each node in its list of connected peer nodes. If a resulting query hit is made, then the node returns some form of query results to the peer node that contacted it or to the originating node. In this manner, the search quickly fans out amongst a large number of nodes.

With reference now to FIG. 2D, a block diagram depicts a typical network topology of nodes within a peer-to-peer network. Peer node 270 has a connection host list 272 that identifies nodes 274-278 to which peer node 270 is connected, and nodes 274-278 have their own connection host lists 280-284, respectively. In this example, node 274 connects to nodes 290-293, and node 292 connects with nodes 294-298.

It should be noted that peer-to-peer networks do not have a structured topology, such as a strictly hierarchical organization amongst the nodes. For this reason, no single server is depicted, though the invention will appropriately function in a server-client relationship. In the peer-to-peer example, node 276 also connects with node 293, and node 278 also connects with node 298. However, in order to distinguish immediately connected nodes from distant nodes, the set of nodes to which a particular node connects may be termed the “root nodes” of the particular node.

As noted above, the present invention is not limited to any particular peer-to-peer protocol that is used to implement the present invention. As background information, though, the Gnutella protocol is described in more detail as an example of the manner in which information may be passed in a peer-to-peer network between nodes that support a file sharing application. Reference may be made to the above description for FIG. 2C and FIG. 2D for components that would support file sharing within a peer-to-peer network using a protocol similar to Gnutella.

Gnutella is an Internet-based file searching/sharing program that combines both search engine functionality and file server functionality in a single application. When a user enters a search term into a Gnutella-enabled application at a node in the peer-to-peer network, a query message is generated with the appropriately formatted information, and the message is sent as a network packet to the user node's connected peers, i.e., peer nodes with which the user's node has already established a connection or session. Special codes within a Gnutella message header indicate the type of message, and each type of message has a unique code.

Any node within a certain distance from the user's node in the peer-to-peer network, i.e., within a certain node “hop count”, will receive the query message; there is no mechanism to kill a query. As a query message moves through the connected nodes, a time-to-live (TTL) data field, which represents the hop count, is decremented. If the TTL field reaches zero, then the receiving node should not forward the query message, i.e., it should “drop the packet”. Otherwise, the receiving node forwards the query message.

Each message contains a Globally Unique Identifier (GUID). When a new message is generated, a new GUID is also generated and placed within the new message. The manner in which the GUID is generated is not specifically specified by the Gnutella standard. When any message is received, the GUID is compared to a list of GUIDs, each of which were stored when its corresponding message was received. If the GUID is in the list, this fact indicates that the receiving node has seen this particular message previously because the GUIDs are supposed to be unique. Hence, if the GUID is in the list, then the node should not forward the received message because the receiving node's peer nodes would have also seen the message, and the packet can be dropped.

In addition, if the receiving node can fulfill the query, then the node creates a query hit (query reply) message and returns it to the node that originated the query message. The query-hit message contains the address and port number of the responding node so that the originating node can send a message back to the responding node to retrieve a file if desired. The query-hit message also contains the connection speed of the responding node and the number of search hits. For each query hit, the query hit message also contains the name of the file that satisfies the query and the size of that file. Other information may be included, such as length of the data content within the message, etc.

If the originating node has sufficient communication bandwidth, the results of the search should be received within a relatively short amount of time. The search results are stored or cached as they are received. The Gnutella-enabled application then presents the search results to the user in some fashion, and the user may select, through some type of user interface in the application, a filename that the user desires to retrieve. The application, which has stored the search results that include one or more nodes that responded with a search hit, can download a selected file to the user's node. Simple HTTP messages can be used for the download operation, such as a “Get” or a “Put” message (for a Gnutella “Push” request).

The Gnutella protocol operates without a central server. Unlike typical search engines, Gnutella searches anonymously, and there is no index. There is also no authentication process nor authorization process. There are other types of messages within the Gnutella protocol, such as “Ping” and “Pong”, for discovering other nodes on the network and for responding to “Ping” messages. Additionally, a “Push” request message allows a node within the network but behind a firewall to be contacted to push a file to the outside of the firewall rather than attempting to pull the file from inside the firewall. It should be noted that the Gnutella protocol specification is an open specification and is subject to modification and fragmentation over time.

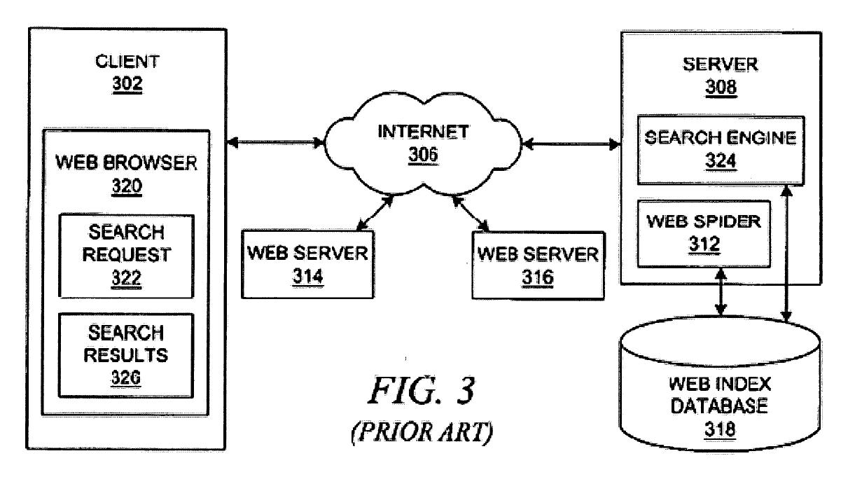

With reference now to FIG. 3, a typical, Web-based, indexing-type, search engine is depicted. Client 302 connects via communication link 304 to the Internet 306, and server 308 connects via communication link 310 to the Internet 306. Server 308 supports Web spider 312, which “crawls” the World Wide Web by following hyperlinks within Web pages or some other means in order to retrieve Web pages and other content from servers 314 and 316. The data gathered by the Web crawler is then indexed and stored within Web index database 318. Certain Web portals perform the indexing process continually.

At some point in time, a user at client 302 may desire to perform a search for specific content on the Web. The user operates Web browser application 320, or some other type of Internet-enabled or Web-enabled application, to retrieve a Web page from server 308 containing a search form for entering a search request or query 322. The user enters a search string, and the search request is sent to search engine 324 on server 308 in an appropriate format, such an HTTP message. The search engine searches through the previously generated index for content that satisfies the user query. If a query-hit is generated, then the search results are returned to client 302, and the browser application displays the results for the user. The user may view the list of results and may determine whether to view the entire contents for an item prior to downloaded the item. In general, the search process is free, but various portals make a profit by selling advertising on their Web site.

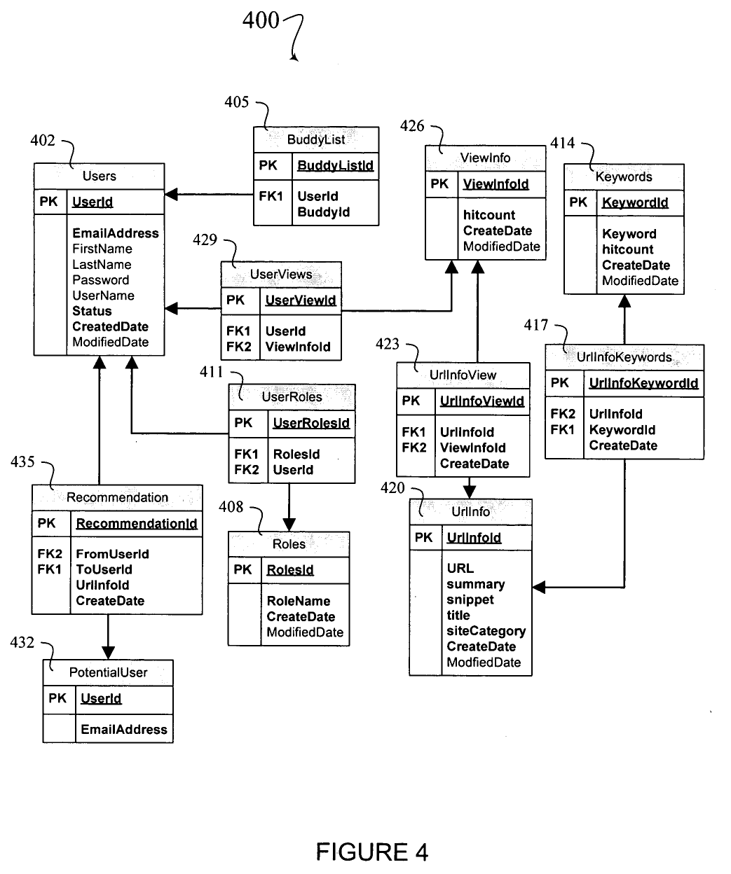

With reference now to FIG. 4, a data flow chart depicts a database structure 400 to enable a presently preferred embodiment of the invention. A unique UserID object 402 is generated to appropriately identify the user and to create appropriate relational blanks within the database. Optionally, a flatfile invoked by the UserID object 402 may advantageously contain the user's e-mail address, first name, last name, a password, a system username, a subscriber status, a created data (a date the user subscribes to the system), and any modified date (a date when the last change to the optional information has been made) may be stored in association with the unique UserID object 402. The unique UserID object 402 allows the invention to relate the user with such unique attributes as to facilitate a user-based social network.

Generally, a second user will be introduced to the invention by referral from a first user. The first user will develop a social network or BuddyList object 405 of second users to help the first user to refine the first user's searching by incorporating the second users' search experience. Thus, the first user accumulates associations with trusted second users to form the BuddyList object 405.

By means out of an association, a BuddyList object 405 is constructed. The BuddyList object 405 defines the social network the user draws upon to refine the user's act of searching the Internet. In a presently preferred embodiment, the BuddyList object is a reflexive relationship, i.e. a BuddyList object 405 is a “colony” of UserID objects 402 linked by elective inclusion. Alternately, the BuddyList object 405 may be unique for each user, such that while a user “A” may include a user “B” in user “A's” BuddyList object 405, that inclusion is not sufficient to cause user “A” to be included in user “B's” BuddyList object 405.

A UserRole object 411, optionally, allows the user to associate the user with various roles that the user fills in living the user's life. A roles database 408 is provided to allow the user to identify the user in this regard. This roles database 408 may be populated by any suitable means but may be predefined or may grow through interaction with the user and with other users. For instance, the roles database 408 may include “Rotarian”, “lawyer”, “hockey player”, “father”, “husband”, “oarsman” and “skier”. These roles are offered to define a demographic classification for the user. While not necessary for the practice of the invention, the roles selected by the user give the opportunity to refine further both the user's interaction with the invention and the interaction of users contained in the users by the list 405. The last, in the presently preferred embodiment, the user, by means of the UserRole object 411. The UserRole object 411 is a constellation of roles the user selects from the roles database 408 and associated with the UserRole object 411.

Having established such identifying associations as the UserRole object 411 and the BuddyList object 405 as the user affirmatively selects, the user now operates the invention. For the purposes of explanation of the process, it is useful to examine interactions between a first user in the course of a first Internet search to populate a keywords database 414 for each user. In a first search, the first user posits a search with a search engine. As set forth with reference to FIG. 3, the user posits the search by constructing a search string, i.e. a series of keywords, and the search string is sent to search engine 324 on server 308 in an appropriate format, such an HTTP message.

The invention develops URLInfoKeyWords object 417 by noting the actions of the search engine in a response to sent keywords. The keywords and the response of the engine to the keywords are recorded, the keywords in the URLInfoKeyWords object 417 and the response in URLInfo object 420. The string of keywords stored in the URLInfoKeyWords object 417 comprises a number of individual keywords drawn from a keyword object 414 and is associated with the URLInfoKeyWords object 417 in a many-to-one relationship. The response by the search engine to the string of keywords, is a series of URL addresses and the series is stored at a URLInfo object 417 in association with the URLInfoKeyWords file 420 that generated the response.

Optionally, the URLInfoKeyWords object 420 may also contain other attributes of the information contained at the URL address. For instance, along with the associated URL address, there may advantageously be stored in the URLInfoKeyWords object 420, a summary attribute of the information stored at the URL address. Similarly, a snippet attribute of the content found at the URL address containing some of the keywords that generated the response might also be advantageously stored in the URLInfoKeyWords object 420. A title attribute also be advantageously stored in the URLInfoKeyWords object 420.

In the most comprehensive embodiment of the invention, it is advantageous to save a view information object in an URLInfoView object 423 in an association with the results of the search. While the URLInfoKeyWords object 420 is a compendium of attributes for one of the addresses returned in the search, URLInfoView object 423 is a listing of the several URLInfoKeyWords objects 420 that make up the response such that the relationship 419 between the URLInfoView object 423 and the URLInfoKeyWords objects 420 is, again, many-to-one. Additionally, it is advantageous to include a date on which the result was delivered by the search engine, thereby taking into account the dynamic nature of the Internet.

A view of the results is created when the user selects various of the results presented and recorded in the URLInfoView object 423 thereby narrowing the search by gleaning only those results the user found useful. In the presently preferred embodiment, the user actively checks those results the user found useful and saves the view in the ViewInfo object 426 and then associates the ViewInfo object 426 with the UserID object 402 in a UserViews Object 429. The URLInfoView object 423 and differs from the results in the ViewInfo object 426 in that the ViewInfo object 426 only stores the results from the URLInfoView object 423 that the user found useful. The ViewInfo object 426 is, in turn associated with the user in the UserViews object 429.

An additional optional function of the invention is the recommendation engine. The recommendation engine gives the user the ability to recommend a site to a friend or colleague while perusing a site in real-time. Tied up with the idea of viral marketing, the recommendation engine works in conjunction with email services allowing a user to forward content found at a URL in an email and send it off to their friends or colleagues with a one-step process to right click. A context menu will appear with an option “Recommend This!”

In a preferred embodiment, a PotentialUser object 432 may well be contained in a “phonebook” or other email directory maintained by the user and containing email addresses. Alternatively, the user may create the PotentialUser object 432 on an “as needed” basis. A RecommendationID object 435 is created to associate the PotentialUser 435 object with the content at the URL and the UserID.

While the preferred embodiment of the database 400, has been presented for purposes of illustration, the invention can be practiced with far fewer objects. For example, with ViewInfo objects 426 associated directly with UserID objects 402, a lookup table would return the results that the user found most useful to the user when submitting that keyword string. Further granularity, as set forth in the preferred embodiment of the database 400 enhances the operation but is not necessary to practice the invention.

The invention may be practice in a number of distinct environments. In a strictly hierarchical environment, i.e. client and server environment, or in several peer-to-peer configurations, the selection of Web content based upon a social network is readily facilitated.

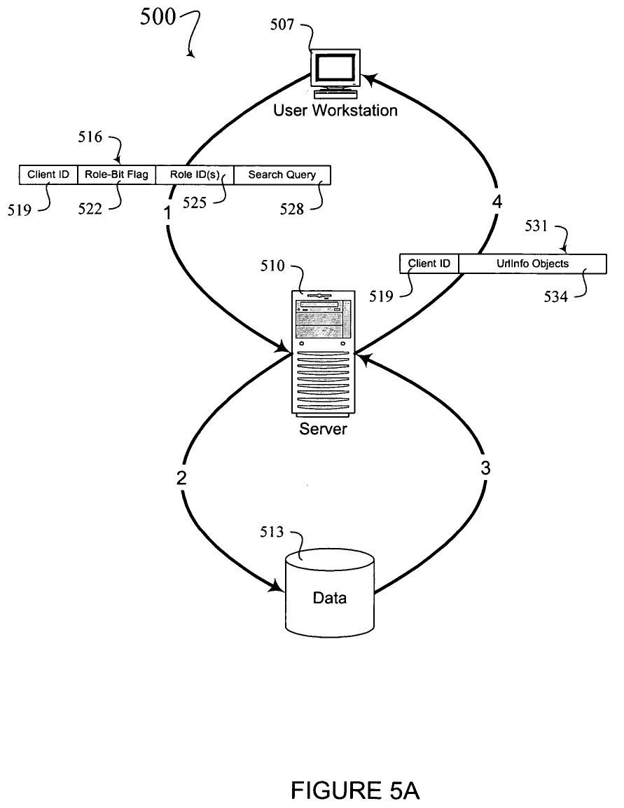

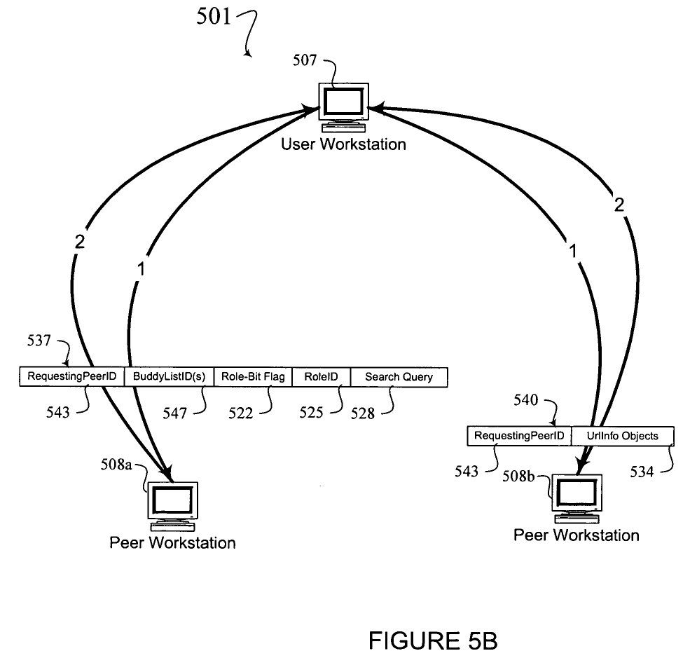

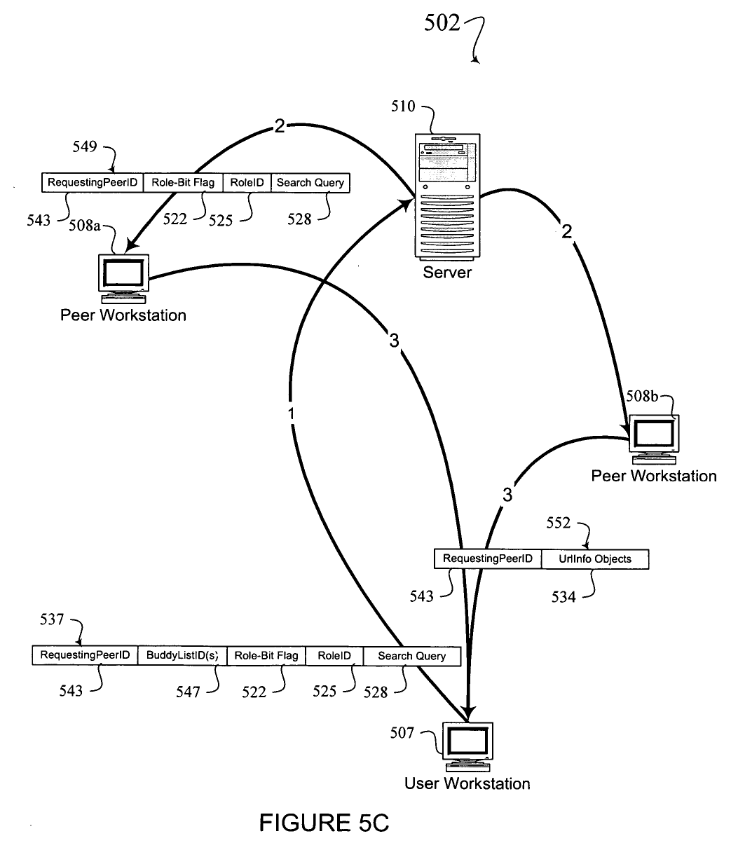

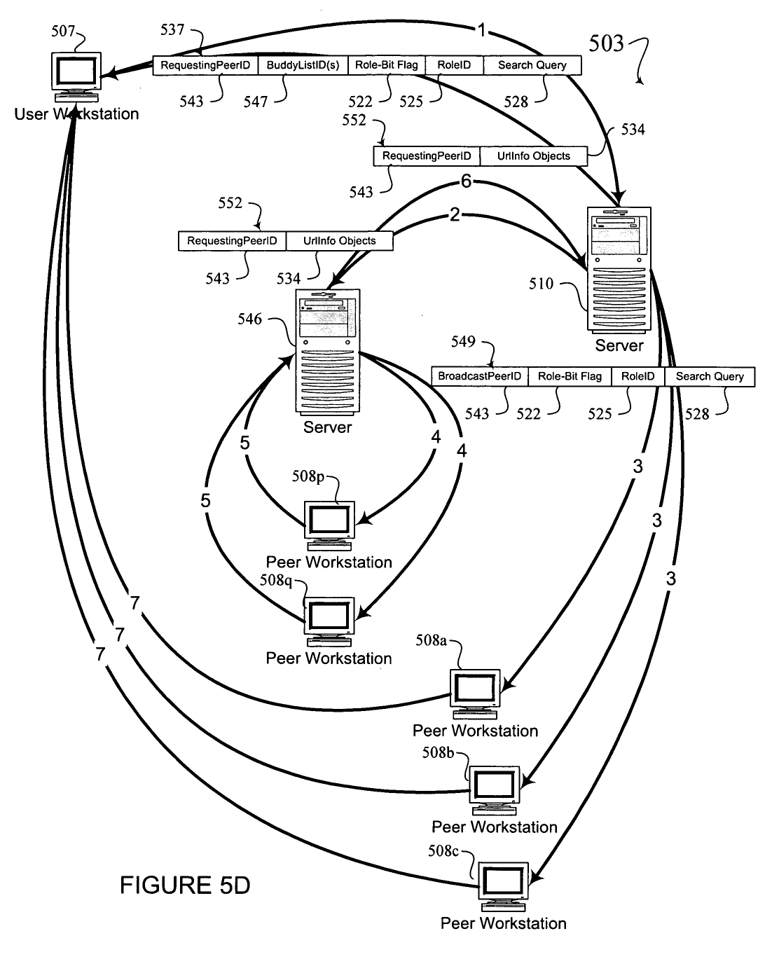

Referring to FIG. 5A, a block diagram of a hierarchical environment is depicted. A user workstation 507 sends a request to the server 510 adhering to a formatted request 516. In a presently preferred embodiment, the formatted request 516 includes a client ID 519, a role-bit flag 522, a role ID 525, and a search query 528.

In this embodiment, the role-bit flag 522 indicates if the search is role-based. A role-based search is a search wherein the user seeks to exploit a specific role associated with the user in order to locate role-specific or role-relevant information in a search of the Internet. By electing to search as one role or another, the user will select a subset of the BuddyList object for winnowing the search results by comparison with successful searches by users in the subset.

At the user's direction, the workstation 507 sends the formatted request 516 to the server 510. In one presently preferred embodiment, the user's workstation 507 simultaneously sends a search query 528 to a search engine by means of an Internet connection. Upon receipt of the formatted request 516, the server compares the search query 528 against search queries stored in the database 513. Where a search query 528 matches or corresponds to a search query stored in the database 513, associated search results 534 stored in the database 513 are returned to the server 510. Once the results are returned to the server 510, the server 510 formats a response 531 for transmission to the user's workstation 507. In a presently preferred embodiment, the response 531 includes the UserID 519, as in the formatted request 519, and the search results 534.

Where the search query 528 was sent to the search engine, the user's workstation optionally filters or orders the response of the search engine according to the search results 534 from the server, displaying the filtered response. If the search query 528 was not sent to the search engine, the workstation 507 displays the search results 534. The displayed results reflect those stored in the database 513.

Referring to FIG. 5B, is a data flowchart depicting the serverless peer-to-peer 501 embodiment of the invention. A user workstation 507 remains as the user interface with the invention. In a presently preferred embodiment of the invention the invention resides as a software “plug-in” for a browser such as Internet Explorer® or Netscape®. As the user invokes a search engine with a search query, the inventive software stores the search query and formulates a formatted request 537. In a presently preferred embodiment the formatted request 537 includes many of the same elements as are present in the formatted request 516 (FIG. 5A) such as the role-bit flag 522, the RoleID 525, and the SearchQuery 528. Additionally, the presently preferred embodiment includes a BroadcastPeerID 543 that serves to identify the user as the ClientID 519 (FIG. 5A) does in the hierarchical embodiment as well as a BuddyListID 547. To some extent, the BuddyList ID may be redundant with the BroadcastPeerID 543 and practicing the invention with some sort of concatenated ID would also serve.

The formatted request 537 is broadcast over the Internet to interrogate peer workstations 508a, 508b for the presence of same or similar requests in databases resident in the inventive software. Each peer workstation 508a, 508b that has such a similar search query on file responds with a formatted response 540. The formatted response 540 indicates the BroadcastPeerID 543 to aid in routing the request and the URLInfoObjects 534 the peer workstation 508a, 508b finds associated with the search query in the software database.

Referring to FIG. 5C, is a data flowchart depicting the server-steered peer-to-peer 502 embodiment of the invention. As in the serverless peer-to-peer 502 embodiment, the user initiates the inventive process with a search of the Internet. The inventive software then formulates a formatted request 537. In a presently preferred embodiment the formatted request 537 includes many of the same elements as are present in the formatted request 516 (FIG. 5A) such as the role-bit flag 522, the RoleID 525, and the SearchQuery 528. Additionally, the presently preferred embodiment includes a BroadcastPeerID 543 that serves to identify the user as the ClientID 519 (FIG. 5A) does in the hierarchical embodiment as well as a BuddyListID 547. Rather than sending the formatted request directly to peers, the user workstation 507 transmits the formatted request 537 to a steering server 510. Advantageously, the steering server 510 may be the repository of the BuddyList database 405 (FIG. 4). In the steering server 510, the inventive software selects peer workstations 508a, 508b for transmitting the request according to associations with the user contained in the BuddyList database and optionally according to the roles selected by the user and contained in the formatted request 537. By directing or steering the formatted request, the social network is employed to enhance the filtering or ordering of results from a search engine. Advantageously, by using the steered server embodiment, the inventive method may be promulgated from a user-subscription service provider.

Once the selected peer workstations 508a and 508b receive the formatted requests, they respond identically to the peer workstations 508a and 508b in the serverless peer-to-peer embodiment (FIG. 5B), by referring to databases resident in the software contained in the peer workstation 508a and 508b. The formatted request 537 is broadcast over the Internet to interrogate peer workstations 508a, 508b for the presence of same or similar requests in databases resident in the inventive software. Each peer workstation 508a, 508b that has such a similar search query on file responds with a formatted response 540. The formatted response 540 indicates the BroadcastPeerID 543 to aid in routing the request and the URLInfoObjects 534 the peer workstation 508a, 508b finds associated with the search query in the software database.

Referring to FIG. 5D, is a data flowchart depicting the extended server-steered peer-to-peer 503 embodiment of the invention. As in the serverless peer-to-peer 502 embodiment, the user initiates the inventive process with a search of the Internet. The inventive software then formulates a formatted request 537. The user workstation 507 transmits the formatted request 537 to a steering server 510. In the steering server 510, the inventive software selects peer workstations 508a, 508b, 508c for transmitting the request according to associations with the user contained in the BuddyList database and optionally according to the roles selected by the user and contained in the formatted request 537. In addition to the transmission to the several peer workstations 508a, 508b, 508c, the server 510 sends the formatted request to node servers 546 in a SearchBuddy™ network. Each of the node servers 546 further steer the formatted request 549 to remote peer workstations 508p, 508q. By directing or steering the formatted request to selected peer workstations 508a, 508b, 508c, 508p, 508q, the social network is employed to enhance the filtering or ordering of results from a search engine.

Once the selected peer workstations 508a, 508b, 508c, 508p, 508q receive the formatted requests, they respond identically to the peer workstations 508a and 508b in the serverless peer-to-peer embodiment (FIG. 5B), by referring to databases resident in the software contained in the peer workstation 508a, 508b, 508c, 508p, 508q. The formatted request 537 is broadcast over the Internet to interrogate peer workstations 508a, 508b, 508c, 508p, 508q for the presence of same or similar requests in databases resident in the inventive software. Each peer workstation 508a, 508b, 508c, 508p, 508q that has such a similar search query on file responds with a formatted response 540.

When the user workstation 507 receives the formatted responses 540 from the various peer workstations 508a, 508b, 508c, 508p, 508q or from the server 510 the inventive software resident thereon will compile the received formatted responses 540 to display them at the user workstation 507. In a presently preferred embodiment, the results are compiled into HTML content to report the results.

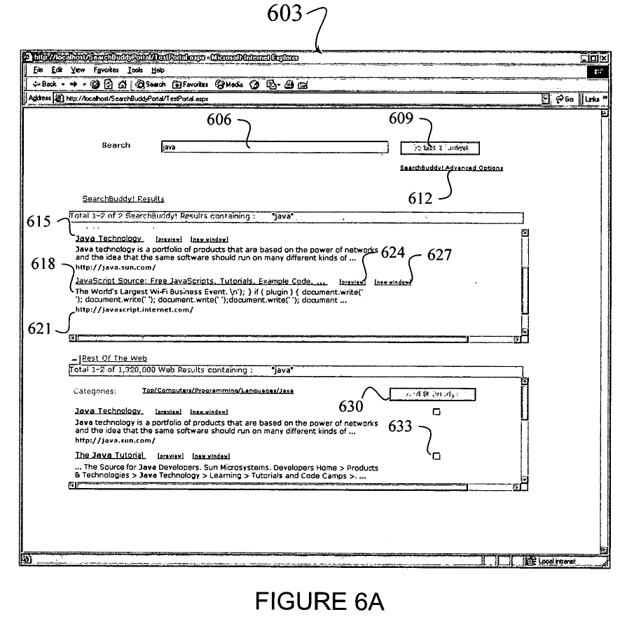

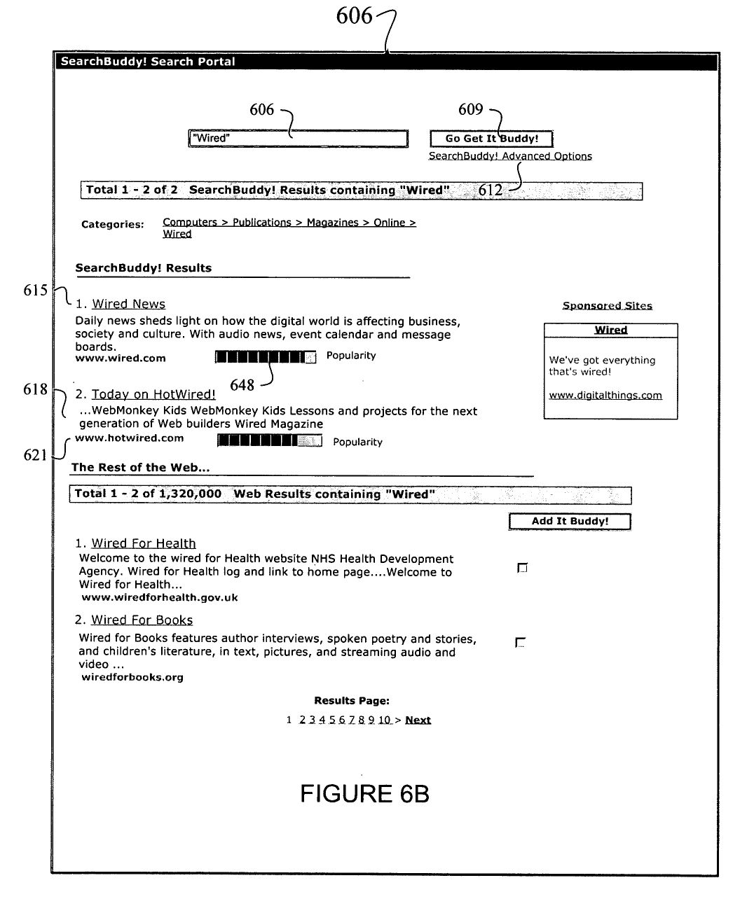

Referring to FIG. 6A, one presently preferred embodiment of the reporting page 603 is depicted. Many features are selected to imitate the reporting format that has become common among various search engines in order to enhance the intuitive nature of the report page 603. A search-refining pane 606 is provided to allow interaction with the search engine in response to the reported results. To execute the search set forth in the refining pane 606, the user activates an execute button 609, in this case optionally labeled “Go get it, Buddy.” Advanced searching options are available in a manner similar to those known in the art, are provided a hot link 612 to a formatting page that enables an automate formulation of Boolean search requests.

The results of the search are displayed in a squib format with a single squib reporting out a page located at a URL address. Each squib has several elements. A first hot button 615 linking to the page at the URL bears the title of the page. A second hot button 621 also linking to the page at the URL bears the URL address. Between the first hot button 615 and the second hot button 621, a short excerpted paragraph or partial paragraph that contains the content found on the page in close proximity to the words comprised in the search query that generated the results. A third hot button 624 allows a preview of the text contained at the site, while a fourth hot button 627 allows review of the site in a new window. While each of the features described herein harmonize the reporting page with those used for common search engines no one or combination of them are necessary for the practice of the invention and are provided only to enhance the dialogue between the user and the inventive software.

An object of the invention is to leverage the search experience of the numerous users to appropriately rate the utility of sites in response to search queries. To facilitate that leveraging process, the software receives feedback from the user in either an active or a passive mode. While the passive mode is accomplished by any of several means including tracking the user's use of the content found at any of the pages (for instance the numbers of uses of links contained at the site or time spent at the site). Alternatively, the active system allows an individual the opportunity to opt a site into the SearchBuddy database by activating check boxes 633 corresponding to relevant sites and then activating an execution button 630 labeled “Add it, Buddy.”

Optionally, as a BuddyList grows and the inventive database is populated with the results of more active searches, an alternate report page 606 will additionally rate sites reported as results are more frequently reported to common searches. As with the reporting page 603 (FIG. 6A), a search-refining pane 606 and an execute button 609, in this case optionally labeled “Go get it, Buddy” are provided along with an advanced searching options hot link 612.

Each squib is enhance with a normalized graphic scale 648 indicating popularity of the reported site. The hot buttons 615 and 621 remain as well as a short excerpted paragraph or partial paragraph that contains the content found on the page in close proximity to the words comprised in the search query that generated the results. Again, while each of the features described herein harmonize the reporting page with those used for common search engines no one or combination of them are necessary for the practice of the invention and are provided only to enhance the dialogue between the user and the inventive software.

As set forth above, a PotentialUser object 432 (FIG. 4) may well be contained in a “phonebook” or other email directory maintained by the user and containing email addresses. Alternatively, the user may create the PotentialUser object 432 on an “as needed” basis. A RecommendationID object 435 is created to associate the PotentialUser 435 object with the content at the URL and the UserID.

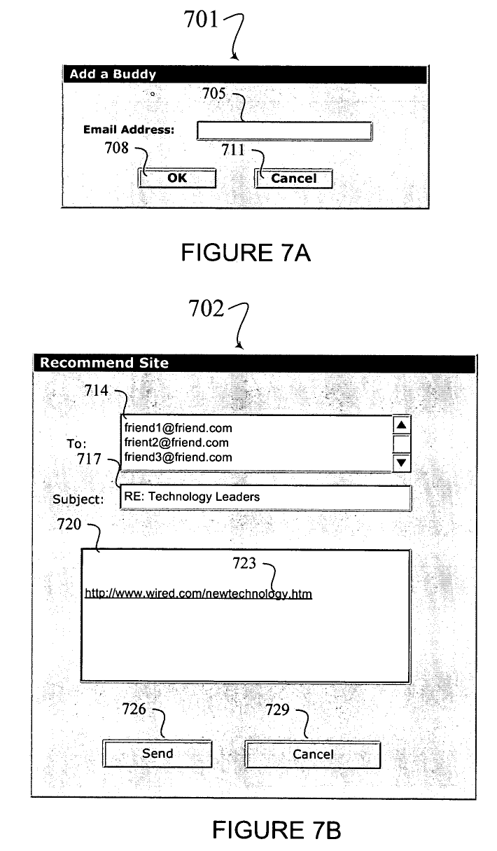

Referring to FIG. 7A, a dialogue box 701 for creating PotentialUser objects 432 (FIG. 4). The inventive software generates the dialogue box 701 to assist the user in augmenting a SearchBuddy database. The dialogue box 701 provides a pane 705 allowing the user to provide an email address to direct a request to enable the inventive software on the email recipient's workstation. As is customary, the dialogue box 701 provides an execute button 708 labeled “OK” and a cancel button 711 labeled “Cancel” affording the choice to the user to execute the action or to cancel it. The dialogue box 701 persists until the user selects either to execute or to cancel the action.

Referring to FIG. 7B, a dialogue box 702 for executing the recommendation process is depicted. The dialogue box 702 will serve to allow recommendation of a website to a potential user at an email address. A pane 714 is provided to the user to allow the listing of one or multiple email addresses. Once the user completes the list of email addresses in the pane 714, the user may assign a subject in a pane 717 to the recommendation. Optionally, where the user provides no subject, the subject line will be filled in with an assigned title of the content found at a recommended URL address 723. In a pane 720, the user may provided desired text of an email message recommending the site. By default the URL 723 is provided in the text of the message. Optionally, the URL 723 may be suppressed in the display of the pane 720. Again, the dialogue box 702 provides an execute button 726 labeled “Send” and a cancel button 729 labeled “Cancel” affording the choice to the user to execute the action or to cancel it. The dialogue box 702 persists until the user selects either to execute or to cancel the action.

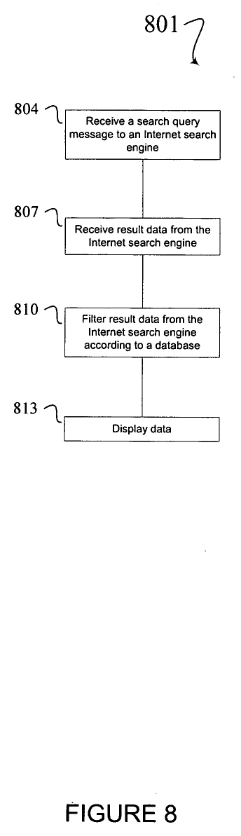

Referring to FIG. 8, a flowchart 801 depicts a method for filtering results of a search of the Internet. At a block 804, filtering Internet content includes receiving a search query message comprising a search query to an Internet search engine.

At a block 807, data is received from the Internet search engine, responsive to the search query message.

At a block 810, filtering of the data produces a data subset. The filter selects data for inclusion in the data subset based upon occurrence of the data in a database. The database includes content selected for inclusion by designated users. As indicated in the discussion above, the database includes the result of several searches by the designated users.

At a block 813, the data subset is displayed in a browser.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

The embodiments of the invention in which an exclusive property or privilege is claimed are defined as follows:

1. A method for filtering Internet content, the method comprising:
receiving a search query message comprising a search query to an Internet search engine;
receiving data from the Internet search engine, the data being responsive to the search query message;
filtering the data to produce a data subset, the filter selecting data for inclusion in the data subset based upon occurrence of the data in a database; the database comprising content selected for inclusion by designated users; and
displaying the data subset in a browser.

2. The method of claim 1, the filtering being further based upon the occurrence the search query in the database.

3. The method of claim 1, wherein the designated users are users designated based upon a role.

4. The method of claim 1, wherein the designated users are users designated based upon personal familiarity.

5. A computer program product on a computer readable medium for use in a distributed data processing system for searching for information within the distributed data processing system, the computer program product comprising:
instructions for receiving a search query message comprising a search query to an Internet search engine;
instructions for receiving data from the Internet search engine, the data being responsive to the search query message;
instructions for filtering the data to produce a data subset, the filter selecting data for inclusion in the data subset based upon occurrence of the data in a database; the database comprising content selected for inclusion by designated users; and
instructions for displaying the data subset in a browser.

6. The computer program product of claim 5, the instructions for filtering being further based upon the occurrence the search query in the database.

7. The computer program product of claim 5, wherein the designated users are users designated based upon a role.

8. The computer program product of claim 5, wherein the designated users are users designated based upon personal familiarity.

9. An apparatus for searching for information within a distributed data processing system, the apparatus comprising:
a first receiving component for receiving a search query message comprising a search query to an Internet search engine;
a second receiving component for receiving data from the Internet search engine, the data being responsive to the search query message;
a filtering component for filtering the data to produce a data subset, the filter selecting data for inclusion in the data subset based upon occurrence of the data in a database; the database comprising content selected for inclusion by designated users; and
a displaying component for displaying the data subset in a browser.

10. The apparatus of claim 9, the filtering component being further based upon the occurrence the search query in the database.

11. The apparatus of claim 9, wherein the designated users are users designated based upon a role.

12. The apparatus of claim 9, wherein the designated users are users designated based upon personal familiarity.

13. A method for searching for information within a distributed data processing system, the method comprising:
receiving, at a server, a search query message comprising a search query from a client to an Internet search engine;
performing a intersystem search of a database in accordance with the search query;
compiling search result data from the intersystem search;
receiving a result message from the Internet search engine; and
merging search result data and the result message to generate result information;
generating a display with the result information.

14. The method of claim 13 wherein:
performing the intersystem search is performing the intersystem search on a hierarchical network.

15. The method of claim 13 wherein:
performing the intersystem search is performing the intersystem search on a peer-to-peer network.

16. The method of claim 13 wherein:
performing the intersystem search is performing the intersystem search of the database, the database including identities of a plurality of selected users.

17. The method of claim 16 further comprising:
filtering search result data according to data stored in association with the plurality of selected users.

18. A computer program product on a computer readable medium for use in a distributed data processing system for searching for information within the distributed data processing system, the computer program product comprising:
instructions for receiving, at a server, a search query message comprising a search query from a client to an Internet search engine;
instructions for performing a intersystem search of a database in accordance with the search query;
instructions for compiling search result data from the intersystem search;
instructions for receiving a result message from the Internet search engine; and
instructions for merging search result data and the result message to generate result information;
instructions for generating a display with the result information.

19. The computer program product of claim 18 wherein:
performing the intersystem search is performing the intersystem search on a hierarchical network.

20. The computer program product of claim 18 wherein:
performing the intersystem search is performing the intersystem search on a peer-to-peer network.

21. The computer program product of claim 18 wherein:
performing the intersystem search is performing the intersystem search of the database, the database including identities of a plurality of selected users.

22. The computer program product of claim 18 further comprising:
instructions for filtering search result data according to data stored in association with the plurality of selected users.

23. An apparatus for searching for information within a distributed data processing system, the apparatus comprising:
a first receiving component for receiving, at a server, a search query message comprising a search query from a client to an Internet search engine;
a searching component for performing a intersystem search of a database in accordance with the search query;
a compiling component for compiling search result data from the intersystem search;
a second receiving component for receiving a result message from the Internet search engine; and
a composing component for merging search result data and the result message to generate result information;
a generating component for generating a display with the result information.

24. The apparatus of claim 23 wherein:
the searching component for performing the intersystem search is performing the intersystem search on a hierarchical network.

25. The apparatus of claim 23 wherein:
the searching component for performing the intersystem search is performing the intersystem search on a hierarchical network.

26. The apparatus of claim 23 wherein:
the searching component for performing the intersystem search is performing the intersystem search of the database, the database including identities of a plurality of selected users.

27. The computer program product of claim 18 further comprising:
a filtering component for filtering search result data according to data stored in association with the plurality of selected users.
